(19) United States
(12) Patent Application Publication
(10) Pub. No.: US 2011/0320322 A1
(43) Pub. Date: Dec. 29, 2011

(54) INVENTORY MONITORING USING COMPLEMENTARY MODES FOR ITEM IDENTIFICATION

(75) Inventors: Thomas K. Roslak, Northport, NY (US); David M. Findling, Lisle, IL (US)

(73) Assignee: SYMBOL TECHNOLOGIES, INC., SCHAUMBURG, IL (US)

(21) Appl. No.: 12/823,825

(22) Filed: Jun. 25, 2010

(51) Int. Cl. G06Q 10/00; G06K 7/10

(52) U.S. Cl. 705/28; 235/385

(57) ABSTRACT

A technique for inventory monitoring using complementary modes for item identification includes; storing items in known locations within a defined area; tracking a user in the defined area; detecting that the user has removed an item from its known storage location; ascertaining a first identity of the item using first means; scanning the item to obtain a second identity of the item using second means different than the first means; correlating the results from detecting, ascertaining and scanning to determine if there is a discrepancy, and providing an alert if there is a discrepancy. If there is no discrepancy, checkout can proceed.

### FIELD OF THE DISCLOSURE

The present invention relates generally to monitoring inventory and more particularly to inventory monitoring using complementary modes for item identification.

### BACKGROUND

At present, there are many techniques for the electronic monitoring of the movement of stock, which can be used in many different commercial scenarios, such as a retail establishment, a warehouse environment, etc. These monitoring techniques include the scanning of any one of a barcode printed on an item, an Electronic Article Surveillance (EAS) tag affixed to the item, Radio Frequency Identification (RFID) tag embedded in the item, and the like. Even with these sophisticated techniques, there is still a problem in inventories where the amount of incoming stock does not equal the amount of outgoing stock, particularly when there are people handing the stock. For example, if a person is responsible to scan all items they handle in a warehouse, it may be that they forget to scan all their items. In another example, a person using the self-checkout counter in a grocery store may not scan all their items properly.

The only solution to these problems is to provide manual intervention, such as having a warehouse manager double check another's work, or to have someone always monitoring the grocery store self-checkout counter, which wastes productivity.

Accordingly, there is a need to improve inventory monitoring performance when people are handling stock.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system, in accordance with some embodiments of the present invention.

FIG. 2 is a simplified block diagram of a system, in accordance with other embodiments of the present invention.

FIG. 3 is a view of items in known locations, in accordance with the present invention.

FIG. 4 is a view of the removal of an item from inventory, in accordance with the present invention.

FIG. 5 is a flowchart of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides various techniques to improve inventory monitoring performance when people are handling stock. In particular, the present invention reduces the possibility of a person mishandling stock by providing complementary monitoring systems to ensure that a person is properly taking items from stock.

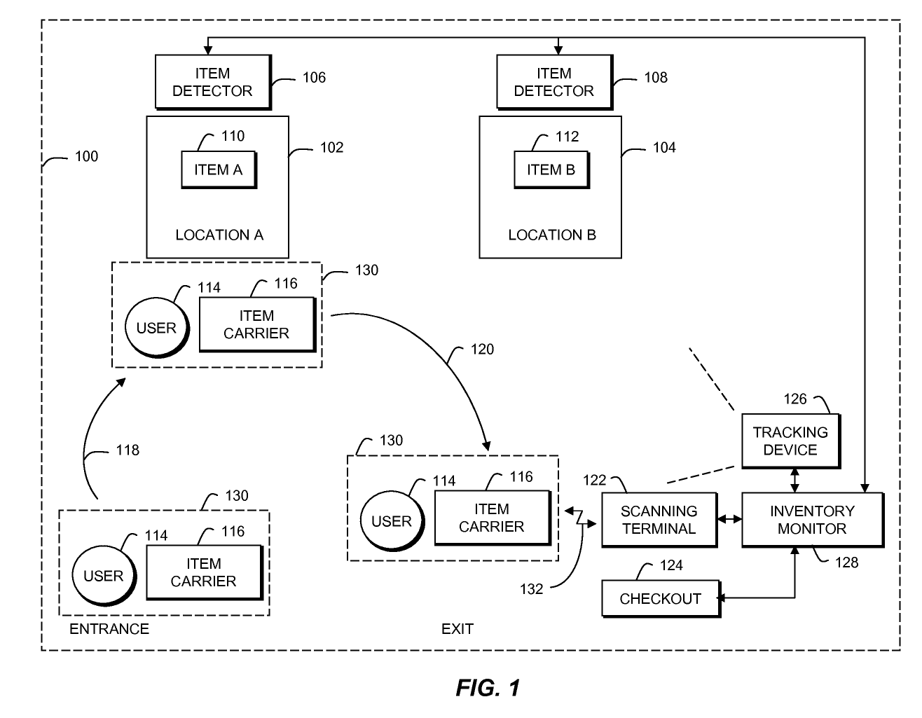

FIG. 1 is a block diagram depiction of a system that can use various optical or wireless communication technologies, such as for identification purposes. The optical systems can include barcode scanning and optical recognition system, as are known in the art. The wireless systems can include local and wide-area networks, or other IEEE 802.11 wireless communication system. However, it should be recognized that the present invention is also applicable to other wireless communication systems. For example, the description that follows can apply to one or more communication networks that are IEEE 802.xx-based, employing wireless technologies such as IEEE's 802.11, 802.16, or 802.20, modified to implement embodiments of the present invention.

Referring to FIG. 1, there is shown a block diagram of various entities adapted to support the inventive concepts of the preferred embodiments of the present invention. Those skilled in the art will recognize that FIG. 1 does not depict all of the equipment necessary for system to operate but only those system components and logical entities particularly relevant to the description of embodiments herein. For example, scanning terminals, detectors, checkout kiosks, inventory control systems, tracking devices, and wireless access points can all includes processors, communication interfaces, memories, etc. In general, components such as processors, memories, and interfaces are well-known. For example, processing units are known to comprise basic components such as, but not limited to, microprocessors, microcontrollers, memory cache, application-specific integrated circuits (ASICs), and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the inventory monitoring aspect of the present invention may be implemented in any of the devices listed above or distributed across such components. It is within the contemplation of the invention that the operating requirements of the present invention can be implemented in software, firmware or hardware, with the function being implemented in a software processor (or a digital signal processor) being merely a preferred option.

Referring back to FIG. 1, a user 114 enters a defined area 100. For example, the user 114 can be a customer entering the defined area 100 of a retail store. Similarly, the user 114 can be a worker entering the defined area 100 of a warehouse building. The user 114 will be picking up items from stock inventoried within the defined area 100. Inventoried items 110, 112 are stored in known locations 102, 104 within the defined area 100. If the items to be retrieved are small or few in number, the user can move about the defined area without any item carrier 116. However, if the items are large or many in number the user can pick up an optional item carrier 116. Item carriers could include a grocery cart or basket in a grocery store, or a pallet, forklift, hand truck or cart in a warehouse, for example.

A tracking device 126 is used to track the locations and movements of people in the defined area. In one embodiment, the tracking device is an optical system that creates a numbered optical “entity bubble” 130 for the person 114 (and optional carrier 116). It should be noted that the optical system need not attempt to identify the person at all. Since there are given boundary conditions in the defined area (e.g. shelves in a store, or racks in a warehouse), it is fairly simple to determine optically where a person or forklift is by photographic boundaries. The present invention need not identify the user, but only needs to track the location of the entity bubble within the defined area. This is a cost effective, low resolution technique. Of course a high resolution tracking system with facial recognition can also be used to identify and track the user, but this is not a necessary feature and adds cost to the system.

In either event, the user 114 either travels alone, or with an item carrier 116, within the area 100 as an entity bubble 130, which is tracked by the tracking device, such as a ceiling-mounted camera(s) system, for example, with a clear view of the defined area 100 that is not blocked by photographic boundaries. In this example, the tracking device 126 tracks the entity bubble 130 (i.e. user 114 and carrier 116) as it travels 118 from the entrance to location A 102. The system then detects whether an item is removed from location A 102.

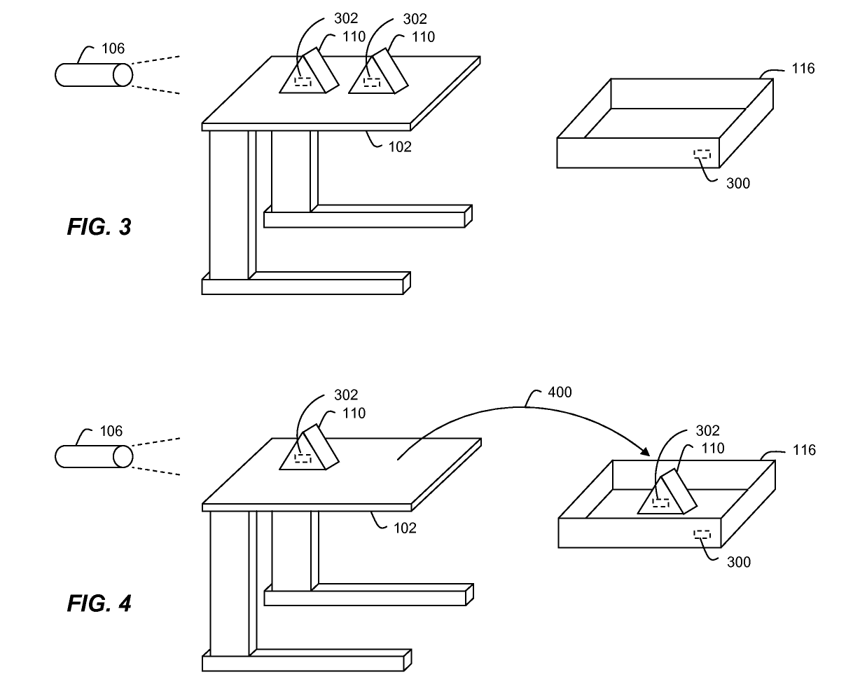

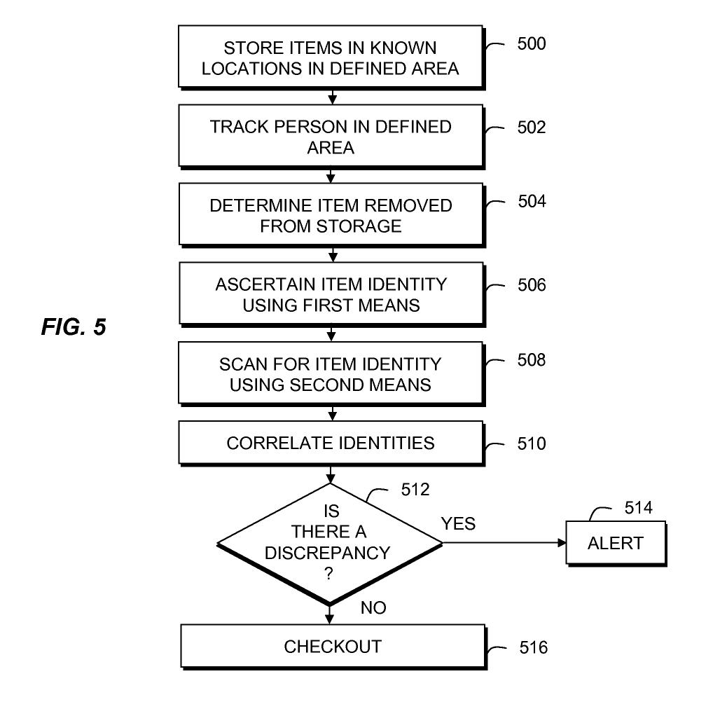

Referring to FIGS. 3 and 4, a local item detector or the tracking device (106 or 126 from FIG. 1) can ascertain whether an item 110 is removed 400 from location A 102 by the user, and optionally can ascertain whether the item A 110 is placed 400 in the user's item carrier 116. This can be accomplished in many ways using optical techniques or techniques that provide scanning of an identification tag 302 of the item 110.

In one technique, the item detector 106 is a local camera at location A, which provides video to the inventory monitor, which then uses optical recognition of the item 110 to detect either or both of the item missing from location A 102, and the item 110 being carried by the user (not shown) or being placed in the user's item carrier 116 (shown). For example, the inventory monitor recognizes the triangular shape of item A or other design elements that is associated with item A such as a color or graphic pattern imprinted on the object. Such parameters can be centrally stored in the inventory monitor, which uses the video signal from the camera to correlate items in the view with stored identifiable features of known items in the location of the camera. Alternatively, the camera can include its own image processing capabilities along with locally stored identity features of items in its location. In this case, the camera can simply inform the inventory monitor that item(s) A has been removed from location A.

In another technique, the tracking device 126 can provide the same function as the local camera, as long as it has sufficient resolution to recognize item features. The tracking device can provide video to the inventory monitor or process the video itself. In this technique, using the tracking device saves the expense of having many item detectors located around the defined area.

In another technique, the item detector 106 is a barcode scanner at location A, where the barcode scanner is used to scan barcodes 302 on items when they are removed 400. The barcode scanner can then forward this information to the inventory monitor.

In another technique, the item detector 106 is a RFID reader at location A, where the RFID reader is used to read RFID tags 302 on items when they are removed 400. The RFID reader can then forward this information to the inventory monitor.

In another technique, the item detector 106 is an EAS tag reader at location A, where the EAS tag reader is used to read EAS tags 302 on items when they are removed 400. The EAS tag reader can then forward this information to the inventory monitor.

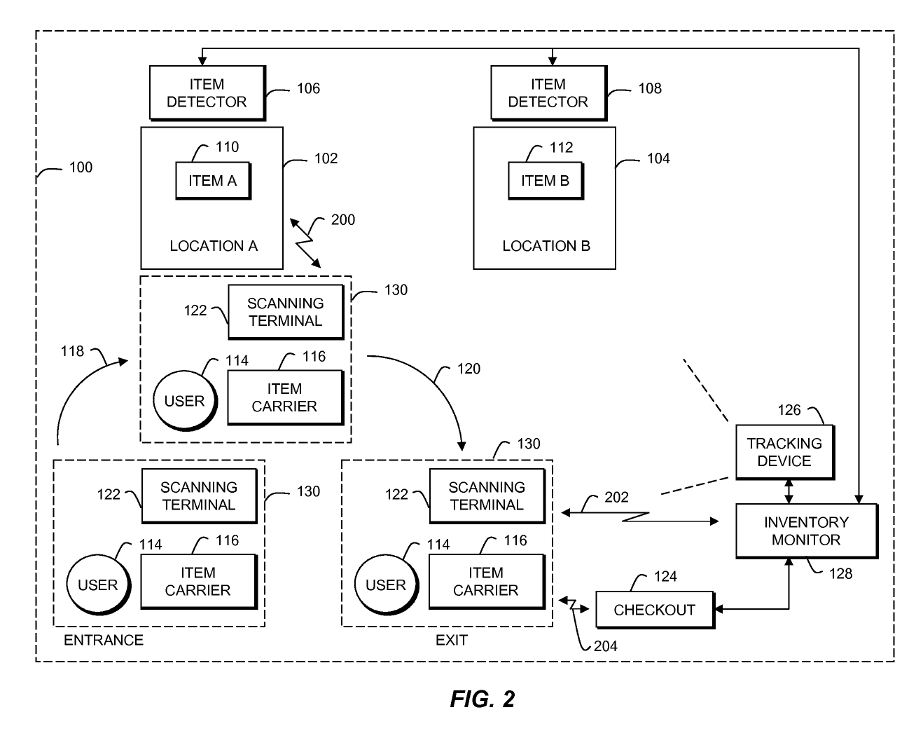

In another technique, the item detector is a personal shopping scanner that will be discussed with reference to FIG. 2 (reference 122). Of course, it should be recognized that any type of item identification system can be used as the item detector 106.

In the above techniques, the location of the user is correlated to known items stored in that location. This narrows down the number of item features that need to be searched to identify an item removed by the user. Moreover, the inventory monitor can anticipate that a user in location A could potentially remove an item A in that location, and then look to see if that item A is actually removed 400. In addition, the system can recognize an inventory problem if a user checks out with another item B 112 when the tracking device recognizes that the user never traveled to location B 104 or that item detector 108 never detected the removal of item B 112 from location B 104.

Optionally, the removed items can be associated with the entity bubble or specifically with the item carrier 116. Again, this can be done by the inventory monitor recognizing, through the local item detector of tracking device, a location of the item carrier, its shape, visually distinguishing features such as a color or graphic design, and/or an identification tag 300 on the carrier, such as a barcode, RFID tag, EAS tag, etc. This has the advantage of recognizing items in the user's carrier while the user is shopping, allowing for easier checkout. For example, when the entity bubble (user) moves 120 to the exit, a scanning terminal would only scan 132 the item carrier 116 identification. The inventory monitor could then supply the checkout kiosk 124 with all the items previously recorded in the item carrier 116, allowing the user to simply pay and leave. Alternatively, at checkout, each item being carried by the item carrier 116 can be scanned again by the scanning terminal 122, which correlates those scanned items against the items previous ascertained by the inventory monitor while the user was in the store. If there is a discrepancy between the items being checked out and those previously ascertained by the inventory monitor, then this discrepancy can be displayed and an alert can be generated to call someone to assist to the user 114 at the checkout kiosk 124. If there is no discrepancy, the user can simply checkout and leave.

FIG. 2 shows a preferred embodiment of the present invention. Again a user 114 enters a defined area 100. The user 114 will be picking up items from stock inventoried within the defined area 100. Inventoried items 110, 112 are stored in known locations 102, 104 within the defined area 100. The user 114 can use an optional item carrier 116. In this embodiment, the user also picks up a personal shopping scanner terminal 122, such as a handheld barcode reader that can wirelessly communicate to a server which uses data from the tracking device 126 to correlate the entity bubble 130 or inventory monitor 128. Optionally, the scanning terminal 122 can be used to scan the item carrier 116 if the carrier as an identifying features such as a barcode or may automatically use an RFID scan to correlate the carrier 116 to the scanning device 122.

The tracking device 126 is used to track the locations and movements of people in the defined area. Again, the tracking device can be an optical system that creates a numbered optical “entity bubble” 130 for the person 114, scanning terminal 122, and optional carrier 116. Alternatively, the tracking device 126 could track the movement of the scanning terminal 122 via wireless communication with the scanning terminal and using known locationing techniques.

In this example, the tracking device 126 tracks the entity bubble 130, or just the scanning terminal 122, as it travels 118 from the entrance to location A 102. The system then detects whether an item is removed from location A 102 and ascertains its identity, as described above for FIG. 1. In this embodiment, the user also scans 200 the removed item A 110 with the portable scanning terminal 122. The scanning terminal 122 can store each item identification or wirelessly send 202 each item identification to the tracking device 126 or inventory monitor 128 for correlation with the ascertained item identities. The removed and identified items are thereby associated with the entity bubble 130, scanning terminal 122, or with the item carrier 116.

The entity bubble (user) then moves 120 to the exit. The checkout kiosk 124 can then identify 204 the scanning terminal 122 or associated item carrier 116. The scanning terminal can then supply 202 the inventory monitor with the items it has scanned, if it has not already done so, or the system can automatically download the item list as scanned and uploaded by the scanning terminal to the kiosk. The inventory monitor then correlates, if it has not already done so, the list of items from the scanning terminal with the items previously ascertained by the item detectors 106 or tracking device 126. If there is a discrepancy between the scanned items and those previously ascertained by the inventory monitor, then this discrepancy can be displayed and an alert can be generated to call someone to assist to the user 114 at the checkout kiosk 124. If there is no discrepancy, the user can simply checkout 204 and leave. Optionally, it may be possible to eliminate checkout completely using the combination of item detection and the scanning terminal. For example, if a customer has a credit or debit account associated with the scanning terminal, they could simply get their receipt from the checkout kiosk 125 and then walk directly out the door.

In an optional embodiment, the scanning terminal can be used for other purposes. For example, the scanning terminal may be accessible through wireless communication with the tracking device or inventory monitor. As the scanning terminal moves through the defined area its location can be tracked and specific offers for items near the location of the scanning terminal can be made to the user. The wireless system, such as WiFi or any other network, can also give a user feedback through the scanning terminal 122 to locate a particular item, such as where the item is located in the area, directions to find the item, its cost, etc.

FIG. 3 illustrates a flowchart of a method for inventory monitoring using complementary modes for item identification, in accordance with the present invention.

The method starts by storing 500 items in known locations within a defined area.

The method includes tracking 502 a user in the defined area. This can be accomplished using optical recognition or by wireless communication means.

The method includes detecting 504 that the user has removed an item from its known storage location. This can be accomplished using optical recognition or by wireless communication means.

The method includes ascertaining 506 a first identity of the removed item using first means 106, This can be accomplished using optical recognition or by wireless communication means, such as image recognition using an imaging device, barcode scanning, RFID scanning, an EAS tag reader, etc.

The method includes scanning 508 the item to obtain a second identity of the item using second 122 means different than the first means. The second means can include a checkout scanner or handheld scanner operated by the user.

The method includes correlating 510 the results from detecting 504, ascertaining 506 and scanning 508 to determine if there is a discrepancy 512, such as a difference between the first and second identities or a difference in the number of items detected and scanned. If there is a discrepancy 512, an alert is generated 514. If there is no discrepancy 512, the user can checkout 516 with their items.

The method can also include automatically checking out 516 the items when the person is leaving the defined area if there is no discrepancy 512. This can include associating an item carrier 116 or personal scanning terminal 122 with the user 114.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for inventory monitoring using complementary modes for item identification, the method comprising:
storing items in known locations within a defined area;
tracking a user in the defined area;
detecting that the user has removed an item from its known storage location;
ascertaining a first identity of the item using first means;
scanning the item to obtain a second identity of the item using second means different than the first means;
correlating the results from detecting, ascertaining and scanning to determine if there is a discrepancy; and
generating an alert if there is a discrepancy.

2. The method of claim 1, wherein optical recognition is used in at least one of tracking, detecting, and ascertaining.

3. The method of claim 1, wherein wireless communication means are used in at least one of tracking, detecting, and ascertaining.

4. The method of claim 1, wherein the discrepancy includes a difference between the first and second identities.

5. The method of claim 1, wherein the discrepancy includes a difference in the number of items detected and scanned.

6. The method of claim 1, wherein the second means is a portable scanning terminal for the person, wherein the scanning terminal also operates for tracking.

7. The method of claim 6, wherein the second means communicates information to the user about items near the location of the scanning terminal.

8. The method of claim 1, further comprising automatically checking out the items when the person is leaving the defined area if there is no discrepancy.

9. The method of claim 8, wherein checking out includes associating an item carrier with the user.

10. A system for inventory monitoring using complementary modes for item identification, the system comprising:
a tracking device operable to track a user in the defined area storing items in known locations;
an item detector operable to detect that the user has removed an item from its known storage location;
first means for ascertaining a first identity of the item;
second means different than the first means, the second means for scanning the item to obtain a second identity of the item;
an inventory monitor operable to correlate the first and second identities from the respective first means and second means, and to generate and alert if there is a discrepancy.

11. The system of claim 10, wherein an imaging device is used for at least one of the tracking device, item detector, and first means.

12. The system of claim 10, wherein wireless communication means are used for at least one of the tracking device, item detector, and first means.

13. The system of claim 10, wherein the discrepancy includes a difference between the first and second identities.

14. The system of claim 10, wherein the discrepancy includes a difference in the number of items detected and scanned.

15. The system of claim 10, wherein the second means is a portable scanning terminal for the person, wherein the scanning terminal also operates for tracking the user.

16. The system of claim 15, wherein the second means communicates information to the user about items near the location of the scanning terminal.

17. The system of claim 10, further comprising a checkout kiosk operable to automatically check out the items when the person is leaving the defined area if there is no discrepancy.

18. The system of claim 10, further comprising a checkout kiosk that associates an item carrier with the user.
